(19) United States
(12) Patent Application Publication
(10) Pub. No.: US 2010/0147329 A1
(43) Pub. Date: Jun. 17, 2010

(54) UPKEEP ARTICLE

(76) Inventor: Guillaume Leymonerie, Ensues La Redonne (FR)

Correspondence Address: LADAS & PARRY LLP, 224 SOUTH MICHIGAN AVENUE, SUITE 1600, CHICAGO, IL, 60604, US

(21) Appl. No.: 12/596,205

(22) PCT Filed: Apr. 17, 2008
(86) PCT No.: PCT/FR08/50685

§ 371 Date: Oct. 16, 2009

(30) Foreign Application Priority Data
Apr. 19, 2007 (FR) 0754564

(51) Int. Cl. A47L 13/16; B25G 1/04; A47L 13/255; A47L 13/44; D03D 27/00; B32B 3/02

(52) U.S. Cl. 134/6; 15/144.4; 15/223; 428/89

(57) ABSTRACT

An upkeep article for use in a dry or damp environment, having at least external layers, a first layer and a second external layer and an absorbent intermediate layer. The external layer presents on its so-called cleaning surface a first group of loops alternating with a second group of loops. The first group has microfibres and the second has threads having a numbering greater than 1.11 dtex. The upkeep article has a surface density less than 350 g/m2.

The object of the present invention is an upkeep article, having three layers, a first outer layer and a second outer layer and an intermediate foam layer.

Presently, when it is desired to remove dusts or other dry or dead particles of organic origin from a given surface, and subsequently to clean, notably degrease or disinfect said surface, a first upkeep article should be used with a configuration adapted for recovering particles and dusts by dry friction, of the impregnated non-woven gauze type, notably a polypropylene web of the order to 20-30 g/m² impregnated with an oil based on paraffin, and then a second upkeep article should be used of the floorcloth or cleaning strip type, notably for degreasing said surface in a damp environment generally with adjuvant detergents. Said second upkeep articles generally have a surface density from 450 g/m² up to more than 800 g/m². They are formed with an outer layer comprising looped microfibres, an intermediate foam layer and a third outer layer, of the order of 180-200 g/m², with a surface suitable for cooperating with clinging bands of the Velcro® type positioned on the lower face of the platform or head of the broom. Said layers are generally assembled edge to edge by sewing, and notably by overcasting. Disposable wipes also exist on the market, generally in non-woven fabric, specially designed either for wiping or for washing but not fulfilling both functions at once. These wipes are neither economical nor ecological because they cannot be reused. Further, for all the aforementioned reasons, this type of upkeep articles is intended for the general public and does not meet the needs of cleaning professionals. There is therefore a need for a reusable, ecological, economical upkeep article, suitable for the general public and for professionals, and useful both for carrying out wiping or recovery of dusts and dirt particles and washing, notably for degreasing treated surfaces.

For this purpose, the object of the present invention is an upkeep article for dry or wet use, having at least three layers, a first outer layer and a second outer layer, and an intermediate absorbent layer, characterized in that:
said first outer layer has on its so-called cleaning surface a first group of loops alternating with a second group of loops,
said first group includes microfibres and said second group includes threads with numbering greater than 1.11 dtex,
and in that the surface density of said article is less than 350 g/m².

Preferably, the threads having a numbering greater than 1.11 dtex are textured. By textured threads, are meant continuous threads spun with fibres or multi-filamentary threads having been subject to a texturing operation, as known in the state of the art, imparting to said threads crimp and elasticity and volume properties as well as improved touch and appearance.

In the following of the description the term of textured threads will designate threads having numbering greater than 1.11 dtex and having been subject to a texturing operation.

The loops of the first group may alternate with the loops of the second group randomly or according to particular patterns such as zigzags.

The upkeep article includes a first group of loops with microfibres allowing upon wiping a surface to be treated, notably in a dry environment, collection of all the dusts on said surface because of the fineness of the fibres becoming easily embedded in the irregularities of said surface, and the entanglement of which fibres creates a network confining the particles. The second group of loops with textured threads provide, notably in a damp environment, a substantially abrasive effect, combined with the microfibres of the first group providing their significant absorbing and degreasing power. Said article may thus be used for sweeping and washing. Preferably, according to the cleaning procedure, the user changes the upkeep article between sweeping and washing but keeps the same supporting member (or broom), which simplifies cleaning and improves ergonomics, notably for professionals. Storage is also simplified. In order to avoid confusion between articles intended for wiping in a dry environment and those in a damp environment, it is possible to colour certain threads in different shades, notably the textured threads.

The proportion of textured threads should be sufficient relatively to the microfibres so that the wiping article does not have a high friction coefficient on its so-called cleaning surface, which should then oppose significant resistance to sliding, notably in a damp environment, detrimental to the comfort of the user. Preferably, the microfibre loops form more than half of the loops on said cleaning surface while the textured loops account for at least one third of the loops on said surface. This arrangement facilitates the use of the upkeep article and provides efficient wiping in a damp environment as in a dry environment.

The upkeep article according to the present invention has a surface density of less than 350 g/m², which is much less than the surface density of the wet upkeep articles from the state of the art. With this characteristic, it is possible to considerably reduce the cost of use of said article because of reduced consumption of water and of washing products during the upkeep of said article. The life time of an upkeep article according to the present invention generally comprises about fifty washes comprising the following steps: pre-washing, washing, water removal and then drying. The applicant realized that the upkeep article had sufficient surface density for providing efficient wiping, whether this occurs in a damp or dry environment, notably in the domain of hospitals where the surfaces to be cleaned are small, of the order of 20 m²-30 m² for a room. Said article is economical and ecological because it is reusable and may be machine-washed.

The first layer and the second layer may be textiles obtained by weaving or knitting or further be non-wovens or tufts. Preferably, they are made from panels obtained by knitting of the warp or Rachel type. Knitting provides more elasticity and flexibility to the first and second layers thereby facilitating handling of the upkeep article and notably water removal.

The first outer layer preferably has a surface density comprised in the range [180; 250] g/m².

The intermediate layer, preferably in foam of the towelling or foamed polymer type, or in a needled polyester non-woven fabric, forms a reserve of water during the washing of the surface to be treated thereby providing to its user sufficient autonomy for effective cleaning of the whole of said surface. The intermediate layer is preferably taken from the following families of polymers: polyurethane, polyether, polyester, polyamide, or copolymers from these polymers. The intermediate layer also forms a reserve of detergent if the washing water has been added with chemical products, for example fungicides, bactericides, . . . etc. depending on the application. Of course, because of the absorbing power inherent to the textile of the first and second outer layers, the latter also form a reserve of water and optionally of detergent.

The textured threads are preferably selected in the following families of polymers, optionally as a mixture in said threads: polyamide, rayon, cotton, and more particularly polyester. The numbering of the textured threads is preferably comprised between 4 and 8 dtex, for example equal to 5.11 dtex.

The microfibres by definition, have numbering less than or equal to 1.11 dtex, preferably for making the upkeep article according to the present invention, the numbering is comprised between 0.4 dtex and 0.8 dtex, preferably between 0.56 dtex and 0.58 dtex. The microfibres are preferably selected from the following families of polymers, optionally as a mixture: nylon, polypropylene, and polyester. They may be mixed with threads spun from fibres, preferably taken from the following families of polymers: nylon, rayon, cotton, polyester, polypropylene.

The upkeep article may assume any shape from the moment that the latter is adapted to the ergonomics of the surface to be cleaned and facilitates handling of said article. The upkeep article preferably has a rectangular or substantially trapezoidal shape. It may also have a round or elliptical shape.

In an alternative embodiment, the intermediate layer is a foam secured by singeing along its two faces to the first and second outer layers. This technique consists of laminating along its two faces superficially melted by the flame during singeing, the intermediate synthetic foam layer between the first and second outer layers thereby avoiding a less productive and more expensive sewing operation. With this technique, it is possible to obtain an assembly which is very resistant to delamination, without any external provision of adhesive, and avoids possible fraying due to the sewing threads.

Following this singeing operation, the complex formed with the first and second layers and the intermediate layer is cut with ultrasound in order to form an upkeep article. The selected materials forming said layers enable ultrasonic cutting. This cutting technique is accurate, fast, avoids the formation of pills, does not stiffen the edges of said article and does not increase its surface density.

In an alternative embodiment, the intermediate layer is a foam of polyurethane and polyether copolymers, preferably having a density comprised in the range [20; 30] kg/m³. The foam of polyurethane and polyether copolymers is elastic, flexible and has good resistance to abrasion, to tear, and to washing machine washes at 60° C. Moreover, the foam is selected so that the singeing operation is feasible.

This thin foam has a reserve of sufficient water for cleaning a room of the order of 20 m², and sufficient thickness preferably of the order of 3 mm to 5 mm, for conforming with the surface to be wiped in order to collect a maximum number of particles and bacteria and to ensure satisfactory ergonomics.

In an alternative embodiment, the upkeep article has a surface density of less than 250 g/m², notably of the order of 230 g/m².

In an alternative embodiment, the upkeep article has an absorbing power of 3.4 grams of water per gram of said article. It is thus possible to clean the floor of a room of 20 m², without re-humidifying it, with an upkeep article having a so-called cleaning surface area comprised between 250 m² and 1,000 cm², said article having a basis weight of about 230 g/m², including 180 g/m² for the first outer layer. Moreover, said article has an improved water release rate on the surface to be washed as compared with formats of traditional washing articles, as illustrated in the Table below.

| | Absorption capacity | |
|---|---|---|
| Upkeep article | in grams of water per | Water release rate on the |
| composition | gram of upkeep article | surface to be washed |
| A | 3.4 | 69% |
| B | 2 | 60% |

Composition of the upkeep articles:
A: upkeep article according to the present invention
1/1^{st} outer layer: a knit with, on the cleaning surface, 7 columns of loops in polyester microfibres/3 columns of loops in textured polyester threads
2/Polyurethane and polyether copolymer foam
3/2^{nd} outer layer: polyester knit
B: Traditional article on the washing market.
There is no foam in this article
1/1^{st} outer layer: velvet with 85% polyester microfibres and 15% polyamide threads
2/2^{nd} outer layer: polyester knit.

This characteristic provides more autonomy to its user and avoids waste of water and detergent, an important criterion in the case of industrial cleaning where the doses of detergent are measured, sometimes for meeting specific quality criteria e.g. for pharmaceutical industries or leading industries (manufacturing of microprocessors, . . . ).

In an alternative embodiment, the loops at said cleaning surface of the first outer layer have a height comprised in the range [2; 5] mm. In this range, the loops, because of their shape and their size, facilitate the recovery and confinement of particles of dusts or other fine particles.

In an alternative, the first group and the second group of loops form continuous and alternating columns.

The applicant has realized that this layout of the first and second groups of loops improves the efficiency of wiping and especially reduces the friction coefficient of the so-called cleaning surface.

In an alternative embodiment, the number of columns of loops of the first group relatively to the number of columns of loops of the second group on the so-called cleaning surface is of the order to 9 for 1 to 6 for 4, and preferably 7 for 3.

Preferably, the number of columns of loops of the first group comprising microfibres is larger than the number of columns of loops of the second group comprising textured threads. The applicant realized that the best compromise for obtaining performing sweeping and washing was 7 columns of loops comprising polyester microfibres alternating with 3 columns of loops comprising polyester textured threads. This layout corresponds to a weight proportion of 70% of microfibre loops relatively to 30% of loops in textured threads on the first outer layer.

In an alternative embodiment, the first group of loops only comprises polyester microfibres and the second group of loops only comprises polyester textured threads.

The polyester fibres being hydrophobic by definition, have low absorbing power but sufficient for retaining chemical agents without any excess. Further, they release little water on the surface to be washed, so that the latter dries rapidly. By nature, the polyester absorbs fats thereby preventing the latter from being deposited again. The polyester is finally very resistant to abrasion and to chemical products, notably those used in alkaline detergents. As the polyester is synthetic material, by friction of the so-called cleaning surface, the fibres are charged with static electricity thereby attracting more particles. The numbering of the microfibres is comprised preferably between 0.56 dtex and 0.58 dtex. The numbering of the textured threads preferably has the value of 5.11 dtex.

In an alternative embodiment, the second outer layer has on all or part of one of its faces, loops capable of clinging to a supporting cleaning member including hooks, which loops are formed upon knitting of the panel in which said second layer was made.

Preferably, the knit forming the second layer is in polyester so that the upkeep article is easily recyclable, the first layer also being in polyester. The second outer layer preferably has a surface density of the order of 20-50 g/m².

Preferably, the loops are formed by apertures or ‘openwork’ in the knit of the second outer layer, through which the foam of the intermediate layer is visible. Hooks and/or loops of the self-clinging type, are able to firmly cling to the surface of the knit of the second outer layer.

The preceding upkeep article as described may be used in a cleaning set which comprises:
a supporting member consisting in a telescopic handle removably attached to a platform, the lower face of which is fitted with self-clinging hooks,
and said upkeep article capable of being attached onto the lower face of said platform by the loops of one of its two faces.

The telescopic handle has an adjustable length by definition and with it, its user may easily access and clean surfaces in height. As said upkeep article is firmly attached by the self-clinging attachment system on the lower face of the platform or “head”, which is removably attached to the telescopic handle, the user does not have to bend down in order to recover said upkeep article, it is sufficient to pivot the telescopic handle.

The object of the present invention according to a second aspect is a method for cleaning a given surface comprising in a characteristic way a first step for wiping said surface in a dry environment with view to removing dust with a first cleaning set as described above, and then a second step for wiping in a damp environment, said surface with view to washing it with a second cleaning set as described above. The first and second cleaning sets have the same supporting member.

Thus, during the first step, the user uses a first supporting member and a first upkeep article for sweeping. Next, without bending down, he/she replaces the first upkeep article with a second article on the platform of the first supporting member in order to carry out washing. This method preferably is particularly suitable for reduced surfaces, of the order of 20 m²-30 m².

Advantageously, the outer layers of said articles have loops or “openwork” capable of cooperating for their fastening with hooks and/or loops of the Velcro® type positioned on the platform of a same supporting member. The user, notably in the field of professional cleaning, thus only needs one single supporting member on his/her cart and not two, respectively adapted in the state of the art to impregnated non-woven fabric for removing dust and to the cotton or microfibre strip having a surface density above 450 g/m² for washing. Indeed, in the state of the art, the use of two upkeep articles having very different characteristics, requires specific supporting members. The use of very lightweight pre-impregnated non-woven fabric for example requires a sufficiently heavy platform for carrying along said non-woven, which reduces the ergonomics of the station.

The present invention will be better understood upon reading an exemplary embodiment cited as being non-limiting and illustrated by the appended drawings, wherein:

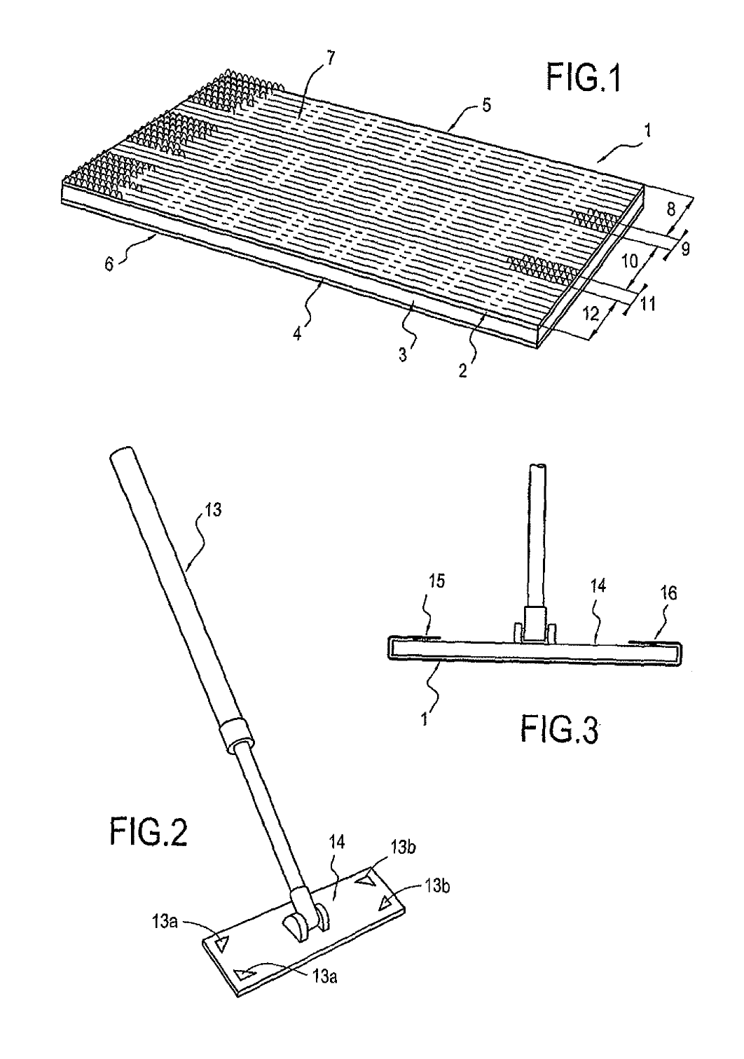

FIG. 1 is a schematic perspective illustration of the upkeep article,

FIG. 2 is a schematic perspective illustration of a telescopic handle removably attached to a platform,

FIG. 3 is a schematic side view illustration of the platform alone onto which is attached an upkeep article.

The upkeep article 1 comprises three layers: a first outer layer 2, a second outer layer 4 and an intermediate layer 3. With said article 1, it is possible to collect dusts from a surface and to wash it. For this purpose, the first outer layer 2 has a so-called cleaning surface 5, which is provided with groups of columns of alternating loops. In FIG. 1 three first groups of columns of identical loops 8, 10 and 12 alternating with two second groups of columns of identical loops 9 and 11 are distinguished. The three first groups 8, 10 and 12 consist of polyester microfibres and the two second groups 9 and 11 consist of polyester textured threads. Preferably, the polyester textured threads have numbering equal to about 5.11 dtex and the polyester microfibres have numbering comprised between 0.56 dtex and 0.58 dtex.

The first outer layer 2 may be made from a knitted woven panel or further from tuft or non-woven fabric. Said panel is knitted according to knitting of the warp or Rachel type, more particularly according to a Rachel type weave with which run-resistant knits may notably be obtained. The first layer 2 has a surface density comprised in the range [180; 250] g/m², and preferably equal to 180 g/m².

The intermediate layer 3 is secured by singeing along its two faces, to the first 2 and second 4 outer layers. This technique consists of superficially singeing each face to be laminated of the intermediate layer 3 thereby avoiding less productive sewing and risks of fraying. Thus, sharp edges are thereby obtained and retain the flexibility of the layers 2, 3 and 4 making up the article 1.

The loops 7 at the so-called cleaning surface 5 have a height preferably comprised in the [2; 5] mm range. Because of their shape and their dimensions, with these loops 7 it is possible to collect and confine more dusts than if the first outer layer 2 was a knit or a velvet fabric.

The intermediate layer 3 is preferably selected from the following families of polymers or copolymers: polyester, polyether or polyurethane.

More particularly, the intermediate layer 3 is a polyurethane and polyether copolymer foam preferably having a density comprised in the [20; 30] kg/m³ range, preferably equal to about 25 kg/m³, providing good resistance to abrasion and to compression of the upkeep article. The intermediate layer 3 has a surface density comprised in the [20; 50] g/m² range and preferably equal to 30 g/m². The intermediate layer 3 forms a reserve of water and optionally of detergent during washing. These first and second groups, because of the fibres or threads with make them up, give to the upkeep article the possibility of being used both for recovering dusts and other particles by dry friction and for washing and degreasing surfaces in a damp environment without necessarily any detergent. Indeed, by dry rubbing microfibres on a given surface, the latter are positively charged by a static electricity phenomenon and attract dusts and other fine particles.

In the same way, in a damp environment, during washing, the microfibres are very absorbent and may degrease a surface without any detergent. The textured threads have much greater numbering and apparent volume because of their crimp than microfibres, allowing them to exert slight abrasion on the surface to be upkept in a dry environment as in a damp environment, facilitating detachment of the particles from said surface. Moreover, the textured polyester threads reduce the friction coefficient of the so-called cleaning surface 5 by facilitating sliding of the upkeep article during wiping, notably in a damp environment.

This layer 3 preferably has an absorption capacity of 3.4 g of water per g of said article 1. During washing, the article 1 gradually releases water on the surface to be cleaned thereby ensuring degreasing and optionally uniform disinfection if detergents have been added to the washing water.

The number of columns of loops of the first groups 8, 10 and 12 is comprised between 7 and 9 for a number of columns of loops of the second groups 9 and 11 ranging from 1 to 4. In FIG. 1, there are 7 columns of loops in the first groups 8, 10 and 12 for 3 columns of loops in the second groups 9 and 11. This layout corresponds to a weight proportion of 70% of polyester microfibres for 30% of textured polyester threads. This ratio is optimum in order to produce an upkeep article 1, both efficient for removal of dust and for washing.

The second outer layer 4 has the function of ensuring that the article 1 is secured to the lower face of a platform or head of a broom by means of self-clinging means of the Velcro® type. The second layer 4 is made in a panel which may be knitted, non-woven or woven, and more particularly knitted according to a knit of the warp type producing apertures or ‘openwork’ in the knit through which the foam 3 is visible. The second layer 4 has a surface density comprised in the [20; 50] g/m² range and preferably equal to 20 g/m², and a thickness preferably comprised in the [0.5; 5] mm range. The warp type knit is produced according to a determined weave, preferably jersey, in order to allow clinging with the supported self-clinging means, through the lower face of the platform or head of a broom.

The upkeep article 1 may be part of a cleaning set comprising a telescopic handle 13 removably attached to a platform 14 illustrated in FIG. 2. The platform 14 is provided on its lower face with self-clinging means of the loop-and-hook type capable of engaging into the apertures or “openwork” of the second layer 4. Thus, the user does not have to bend down in order to recover the upkeep article 1. Further, the platform 14 is provided with self-clinging means 13a and 13b also on its upper face along its two small sides. In FIG. 3, the ends 15 and 16 of the article are folded onto the self-clinging means 13a and 13b in order to strengthen the securing of article 1 to the platform 14.

1. An upkeep article for use in a dry or wet environment, having at least three layers, a first outer layer and a second outer layer and an absorbent intermediate layer, wherein:
said first outer layer has a first group of loops alternating with a second group of loops,
said first group includes microfibres and said second group includes threads with numbering greater than 1.11 dtex,
said upkeep article has a surface density of less than 350 g/m².

2. The upkeep article according to claim 1, wherein the intermediate layer is in a foam secured by singeing along its two faces to the first and second outer layers.

3. The upkeep article according to claim 1, wherein the intermediate layer is a foam of polyurethane and polyether copolymers.

4. The upkeep article according to claim 1, having a surface density of less than 250 g/m².

5. The upkeep article according to claim 1, having an absorbing power of about 3.4 g of water per g of said article.

6. The upkeep article according to claim 1, wherein the loops on the outer surface of the first outer layer have a height of about 2.5 mm.

7. The upkeep article according to claim 1, wherein the first group and the second group of loops form continuous and alternating columns.

8. The upkeep article according to claim 1, wherein the number of columns of loops of the first group relatively to the number of columns of second group is of the order of 9/1 to 6/4.

9. The upkeep article according to claim 1, wherein the first group of loops only comprises polyester microfibres and the second group of loops only comprise textured polyester threads.

10. The upkeep article according to claim 1, wherein the second outer layer has on all or part of one of its faces loops capable of clinging to a supporting clinging member including hooks, said loops are formed during the knitting of the panel in which said second layer was made.

11. A cleaning set comprising:
a supporting member having a telescopic handle removably attached to a platform, a lower face of which is fitted with self-clinging hooks,
and the upkeep article according to claim 10 capable of being attached to the lower face of said platform by the loops of one of two faces of the upkeep article.

12. A method for cleaning a given surface comprising the following steps:
a first step for wiping in a dry environment said surface with a view to removing dust with a first cleaning set according to claim 11, and then
a second step for wiping in a damp environment said surface with a view to washing with a second cleaning set according to claim 11, and
wherein the first and second cleaning sets have the same supporting member.
